(19) United States
(12) Patent Application Publication
(10) Pub. No.: US 2026/0264487 A1
(43) Pub. Date: Sep. 10, 2026

(54) Retractable Small-Engine-Machine Lifter for Mobile Repairs

(71) Applicant: Gavin Tran Bau Duong, Whitchurch-Stouffville (CA)

(72) Inventor: Gavin Tran Bau Duong, Whitchurch-Stouffville (CA)

(21) Appl. No.: 19/072,167

(22) Filed: Mar. 6, 2025

(51) Int. Cl. B60J 5/10; B60N 3/00; B60P 1/43; E05F 15/53; E05F 15/77

(52) U.S. Cl. CPC B60J 5/108; B60N 3/002; B60P 1/435; E05F 15/53; E05F 15/77; E05Y 2900/516

(57) ABSTRACT

The present disclosure provides a multipurpose tailgate (MPT) that has a load lifter for repairing small engine machines or tools like tractors, lawnmowers, and light utility vehicles at a client's location. The MPT comprises: a rear vehicle door that serves as a ramp and load support platform. The MPT raises a machine to a desired height for repairs with the aid of two hydraulic cylinders, a plurality of different shaped trays with wheel locking holes for securing a machine's wheels. The trays can be extended at different lengths and distances apart. The MPT can provide improved convenience for on-spot repairs, increased space utilization, increased safety and security for holding a machine on the MPT, increased functionality for the MPT to accommodate a wide selection of small engine machines in different repairing positions, service requirements, and increased adaptability to aversive environments.

### FIELD OF THE INVENTION

The present disclosure is in the field of mechanical engineering, small engine machines and their repair, hydraulic systems, MPTs of vehicles, back door used as a ramp and lifter, and especially, a MPT of a service vehicle used as a ramp for the purpose of repairing small-engine-machines like tractors, lawnmowers, and light utility vehicles.

### BACKGROUND

Lawnmowers and snow blowers are examples of machines with small internal combustion engines used at home or commercially. When they require maintenance or repairing work, e.g., oil changes, tire, and part repairs or replacement, washing, blade changes, etc., such machines may be too heavy and/or large to be transported to a repair shop conveniently. Therefore, a means to repair those machines on the client's location (on-spot repairing) is required.

Normal jacks may be used for portable or at-home repairs. However, they are less useful for repairing smaller lawnmowers and snow blowers since they cannot raise the machine high enough to access the engine from the underside. In the case of two-wheeled snow blowers, car jacks simply cannot be properly placed to lift the entire machine.

A lift is more suitable for the purpose; however, lifts are usually larger, and either stationary (i.e., car lift) or are not designed to travel long distances (i.e., forklift). Hereinafter, the term ‘lift’ is interchangeable with lifter. One exception is a lift table, which is a device that employs a scissors mechanism to raise or lower goods or persons; however, it still requires an individual to initially lift the lawnmower or machine to be repaired onto the table. Furthermore, the table platform is solid, preventing users from accessing the underside of the machine for engine repairing. Hereinafter, the term ‘user’ explicitly refers to an operator of the lifter and trained mechanic technician who repairs the small engine machines. Overall, there is a lack of lifts that can be ideally used for repairing machines at a customer's location.

Existing tools or machines for onsite repairs face several challenges that make it less ideal for fixing machines with small engines: (1) many of them have a large footprint. In other words, they take up 30 more space within a storage container, such as the rear compartment of a vehicle like a tailgate of a van; (2) many machines and tools for on-spot repairs do not have the capability or flexibility to access the engine from the underneath for repairing; for example, relating back to the example of the lift table, there is no means to access the underside of the machine (3) they have less flexibility, options, and functionalities for on-spot repairing work; that is, they are not flexible for mobile on-spot repairs in terms of the kinds of 35 machines and tools can be repaired, the convenience, and efficiency of repair can achieve. For example, existing load supports for lift platforms have a fixed width and cannot adjustments track width for different small engine machines; or the existing tools do not support repairing two machines at the same time; (4) the adaptation to the service environment may be limited when it comes to performing repairs in less ideal conditions. For example, existing lifters cannot be leveled on an angle for repairing work at a sloped or 40 uneven parking location. Therefore, they need to be brought to a flat location nearby.

Some service vehicle with rear doors, such as the tailgate of a pickup truck, can be used as a table stand to support certain objects for certain purposes such as those in U.S. Pat. Nos. 3,467,266A, 3,883,014A, 5,954,383A, 3,305,112A, and 2,542,047A. However, no existing vehicle MPT or tailgate can be used to lift a small engine machine on its own; the machine is normally heavy; the existing MPT or tailgate mechanisms are not strong or secure enough to lift up a small engine machine from the ground. For example, a typical MPT is from a van or truck. Some of such doors can be used as a ramp for loading or unloading goods into the tailgate. Another notable issue is that doors are solid and closed under the machine, so a user cannot access the underside of a machine to be repaired. Furthermore, there is nothing that could support and secure a small engine machine in place while it is being repaired, even if it can be placed onto the door.

The present disclosure provides a new mobile lifter design in the form of a MPT of a mobile service vehicle used as a ramp and door for repairing small engine machines/tools on the client's location. The MPT device improves upon the following aspects: (1) small device footage; increased service vehicle space utilization efficiency; (2) increased reliability, safety, and security for the MPT and the small engine machine; (3) increased convenience and efficiency for on-spot repairs; (4) increased functionality and flexibility for repairing a wider range of machines with different track widths and different engine placements; (5) increased adaptability to repair a small engine machine under wide different environments and conditions.

### BRIEF SUMMARY OF THE INVENTION

The present disclosure provides a mobile lift design that uses a service vehicle's tailgate door as a ramp and load lifter for repairing small engine machines or tools at client's location. An object of the MPT is to provide flexible and convenient on-spot repair services, particularly for the small-sized engine but relatively heavy machines like tractors, snowblowers, lawnmowers, and other light utility vehicles, machines, and tools which are normally inconvenient, expensive, or impossible for a client to transport them to a repair shop for services. The present disclosure includes the following major aspects of the invention: (1) on-vehicle tailgate door doubled as a ramp and load support mechanism using a pair of hydraulic cylinders; (2) various types of the loading trays; (3) flexible and customizable setup options with different trays, relative positions, and their position adjustment and locking mechanisms; (4) safety legs and wheel locking mechanism; (5) flexible repairing service options and capabilities; (6) how a minimal footprint can be achieved when the MPT is closed and retracted.

Another object of the disclosure is to allow existing box-truck vehicles to be retrofitted with an MPT. The MPT can replace existing box-truck MPTs and pivots along a hinge near the bottom of the vehicle to open. The door then serves as a ramp for loading machines to be repaired. When a machine is loaded onto the MPT, it will be raised upward to act as a load support for a repairing platform. The repairing platform comprises all the tools, setups, and environments used during the on-spot repairing. The ramp and load support functions are accomplished using a hydraulic system with two hydraulic cylinders below the MPT and the body of the vehicle, one on each side of the service vehicle. The cylinders extent/retract simultaneously near the hinge and cause the MPT to open and close automatically.

Another object of the MPT is to allow small engine machines to be loaded with the assistance of telescoping loading trays (TLTs) having multiple shapes. In a typical embodiment of the present disclosure, two I-shaped trays (I-trays) are inserted into two of the four or more tray slots in the MPT. Depending on the repair scenario, the I-tray can be switched out for a different type, for example, an L-shaped with two I-shaped tray-segments merged perpendicularly to each other and an h-shaped tray (h-tray) with a space between merged segments to gain better access to a machine's underside.

Another object of the MPT is to provide TLTs that are detachable components which can be installed and locked into any of the multiple tray slots along the loading edge (opposite of the hinged edge) of the MPT. The setup of trays is flexible and customizable. A TLT can be extended or retracted more or less from the tray slot to have its length adapted to actual needs. Additionally, the TLTs can be placed at different lateral distances apart for adapting different machine track lengths (widths). In one of the exemplary embodiments of the present disclosure, the inserted end of the TLT has two hollow locking pin slots, which line up near the loading edge of the MPT. A locking pin is inserted into one of these slots to lock the tray in one of two longitudinal positions.

Another object of the MPT is to provide supplementary load support in the form of the following: two safety legs on both sides of the MPT that stabilize it when it is in a raised position; wheel locking holes (WLH) on the edges of the trays in the form of rectangular apertures to secure the wheels or track of a small engine machine during the MPT's movements and repairing process.

Another object of the MPT is to provide flexibility during repair options. In one sense of the aspect, the trays (I-, L-, and h-trays) can be placed into the desired tray slots to simultaneously repair more than one machine. In another scenario, the machine has the flexibility to be partially and/or fully loaded onto the MPT according to needs. In yet another scenario, the MPT can be used as a ramp to bring a small engine machine inside a service vehicle in case of bad weather.

Another object of the MPT is to provides a minimal footprint. The MPT pivots along a hinge to an upright position to serve as a closed MPT. The hydraulic cylinders are hidden underneath and around the door hinge. The trays can be retracted into the MPT or completely removed and stored away within the vehicle interior, so the MPT portion takes up minimal space.

Another object of the MPT is to improve mechanic's job greatly by achieving the following: (1) increased security and stability of an elevated small engine machine thanks to the hydraulic system and supplementary load support features (i.e., the safety legs and WLHs); (2) increased service vehicle space utilization thanks to the minimal footprint; (3) increased convenience for the customer since the repair is done at their location. Additionally, it improves convenience for the user repairing the machine; (4) increased functionality for adjusting to different small engine machines with different track widths, wheelbases, and engine placements. This is thanks to the flexible repair options presented by the other aspects, particularly the tray variety, customizable TLT setup, and the hydraulic load support; (5) increased adaptability for repairs in different environments thanks to the flexible repair options presented by the other aspects of the present disclosure.

### BRIEF DESCRIPTION OF THE DRAWINGS

The accompanying drawings, which are included to provide a further understanding of the invention and are incorporated in and constitute a part of this application, illustrate embodiment(s) of the present disclosure and, together with the description, serve to explain the principle of the invention. For simplicity and clarity, the figures of the present disclosure illustrate a general manner of construction of various embodiments. Descriptions and details of well-known features and techniques may be omitted to avoid unnecessarily obscuring the discussion of the present disclosure's described embodiments. It should be understood that the elements of the figures are not necessarily drawn to scale. Some elements' dimensions may be exaggerated relative to other elements for enhancing the understanding of described embodiments. In the drawings:

FIG. 1 illustrates a preferred embodiment of the MPT in the present disclosure in its open and raised position.

FIG. 2 illustrates side views of the MPT in its closed position to its sloped ramp position, then finally to its raised position.

FIG. 3 illustrates a perspective view of a machine wheel secured on the WLH and top views of various installation options of multiple I-shaped TLT, including TLT length and track width adjustment.

FIG. 4 illustrates top views of various types of other TLTs, including I-shaped, L-shaped, and h-shaped TLTs.

FIG. 5 illustrates side views relating to how the MPT raises a front-engine and back-engine machine onsite repairs

FIG. 6 illustrates the perspective and rear views of the MPT simultaneously used during a repair of two machines using L-shaped and h-shaped TLTs.

### DETAILED DESCRIPTION

The present disclosure provides a MPT for repairing small engine machines or tools at the client's location. Various examples of the present invention are shown in the figures. However, the present invention is not limited to the illustrated embodiments. In the following description, specific details are mentioned to give a complete understanding of the present disclosure. However, it may likely be evident to a person of ordinary skill in the art; hence, the present disclosure may be applied without mentioning these specific details. The present disclosure is represented as few embodiments; however, the disclosure is not necessarily limited to the particular embodiments illustrated by the figures or description below. The language employed herein only describes particular embodiments; however, it is not limited to the disclosure's specific embodiments. The terms “they”, “he/she”, or “he or she” are used interchangeably because “they”, “them”, or “their” are considered singular gender-neutral pronouns. The terms “comprise” and/or “comprising” in this specification are intended to specify the presence of stated features, steps, operations, elements, and/or components; however, they do not exclude the presence or addition of other features, steps, operations, elements, components, or groups.

Unless otherwise defined, all terminology used herein, including technical and scientific terms, have the same definition as what is commonly understood by a person of ordinary skill in the art, typically to whom this disclosure belongs. It will be further understood that terms, such as those defined in commonly used dictionaries, should be interpreted as having the same meaning as defined in the context of the relevant art and the present disclosure. Such terms should not be construed in an overly strict sense unless explicitly described herein. It should be understood that multiple techniques and steps are disclosed in the description, each with its own benefit. Each technique or step can also be utilized in conjunction with a single, multiple, or all of the other disclosed techniques or steps. For brevity, the description will avoid repeating each possible combination of the steps unnecessarily. Nonetheless, it should be understood that such combinations are within the scope of the disclosure. Reference will now be made in detail to some embodiments of the present invention, examples of which are illustrated in the accompanying figures.

The MPT is integrated as part of existing box truck's MPT to serve as a ramp and is made of a rigid material such as but not limited to steel, aluminum and the like. The device also has TLTs that can be inserted into or removed from tray slots at the loading end of the MPT. The TLTs are also made of a rigid material such as but not limited to steel, aluminum etc. and allow a small engine machine to load its wheels onto the MPT to be lifted to a raised position. Hereinafter, the plural term ‘wheels’ implies the front or back wheels of a machine, and a pair of the front or rear wheels is interchangeable with ‘wheel track’ or ‘track’.

The present disclosure has a few notable aspects. In the first aspect of the present disclosure, the MPT can function as both a ramp and a load support mechanism. This aspect involves a mechanic control, e.g., a hydraulic system consisting of hydraulic cylinders to pivot and support the door. The MPT has two sides: an outer side that acts as a traditional door for a service vehicle; an inner side with a metal plate acting as a MPT surface that allows small vehicles and machines to be loaded onto the MPT. The MPT moves along a vertical sagittal plane to pivot along a hinge located at the bottom of the vehicle's rear opening in line with the interior space's flooring. A hydraulic system powers the movements of the MPT via hydraulic cylinders: one on each side (left and right) of the vehicle. More specifically, the cylinders simultaneously pivot along pivot joints below the MPT and the vehicle's body to pivot the MPT. Both cylinders are simultaneously fed hydraulic oil to move. Hereinafter, the term ‘hydraulic fluid’ is interchangeable with ‘hydraulic oil’. During the opening or closing of the MPT, the cylinders may also be exposed or concealed within openings on the left and right sides of the MPT. In a way, the MPT has a larger range of movement. After a machine is loaded onto the MPT, the hydraulic cylinders pivot upward to a raised position, holding the MPT and small engine machine in place.

In the second aspect of the present disclosure, TLTs may be used to lift a small engine machine. There are three types of TLTs in the present disclosure: (1) a tray in the form of a capital letter ‘I’. This type of tray is hereinafter called an ‘I-shaped tray’ or ‘I-tray’. Each I-tray can be loaded into one of four tray slots located at the MPT's outward loading end (when the MPT is open). The I-tray has a squarish hole for securing a single wheel of a small engine machine. Hereinafter, this ‘hole’ is referred to as a ‘wheel locking holes’ (WLHs); (2) a tray in the form of a capital letter ‘L’. This type of tray is hereinafter called an ‘L-shaped tray’ or ‘L-tray’. The L-tray has two merged segments that are perpendicular to each other: one for insertion and another for holding the track of a small engine machine in place. The inserted segment is a vertical segment aligned with the MPT to enter one of the tray slots. The holding segment is a horizontal segment with two elongated WLHs for holding machines with various track widths; (3) a tray in the form of a small letter ‘h’. This type of tray is hereinafter called an ‘h-shaped tray’ or ‘h-tray’. The h-tray has three distinct segments: a longer vertical insertion segment aligned with the MPT, a shorter vertical outward segment that is also aligned with the MPT, and a perpendicular horizontal bridging segment. The insertion segment enters one of the tray slots and holds one wheel of a small engine machine. An outward segment is located away from the rest of the MPT and holds the other wheel of a small engine. A bridging segment is situated perpendicular to the former two segments, holding them together.

In the third aspect of the present disclosure, there are flexible and customizable setup options with different TLT combinations and adjustments to their relative longitudinal and lateral positions. A TLT can extend from or retract into one of the four tray slots at the loading end of the MPT to adjust its longitudinal position or length. The TLTs can also switch between TLT slots to widen or narrow the lateral distance between TLTs. In the case of an I-tray, this is used to accommodate different small engine machines with different track widths. With the L-trays and h-trays, they can be placed at a lateral distance apart to simultaneously accommodate two small engine machines at a time. The third aspect also comprises a locking mechanism to keep a TLT in place. Each TLT has two vertically-aligned, tray locking pin slots at the TLT's insertion end that line up with the MPT's tray pin holder slot. Once lined up, a tray locking pin is inserted into the tray pin holder slot and tray pin slot to secure a TLT in place. Essentially, the trays can be locked in one of two positions.

In the fourth aspect of the present disclosure, the MPT has supplementary load support mechanisms in the form of safety legs and WLHs. The safety legs are located on the side of the MPT. These safety legs pivot along pivot joints to stand perpendicular when the MPT is in a raised position (in line with the floor of the vehicle's interior and hinge), where they make contact with the ground to support the MPT. Even when the MPT is in a sloped, open position for loading a machine, the safety legs can be angled to support the device. Another load support mechanism involves the TLT's WLHs mentioned in the second aspect. A wheel or track of a small engine machine, depending on the type of TLT, is placed on top of the WLHs. The bottom of the machine's wheel or track goes through the WLH. As a result, the machine stays securely in place as it is raised by the MPT.

The fifth aspect of the present disclosure is the wide variety of repair options. This aspect is the combination of all the previously mentioned aspects put into practice. This flexibility can be seen in a myriad of repair scenarios. For example, in one scenario pertaining to this aspect, the I-trays can be separated at different lateral widths apart to accommodate the track widths of various small engine machines. In another scenario, combining the three types of trays in a certain manner may result in two machines being repaired simultaneously. One combination includes an L-tray in one tray slot on one side of the MPT and an H-tray in another tray slot on the other side of the MPT. Both trays can hold the track of a single vehicle, exemplifying the aspects mentioned earlier. In another scenario, the machine can be loaded in various ways: (1) the track of a machine can be loaded onto a TLT while the other track remains on the ground. This lifts one end of a machine at an angle. This is done with all types of trays; (2) one set of wheels is on the TLTs, while another set is on the MPT surface. The MPT pivots to a raised position parallel to the ground, effectively raising the machine to a leveled position; this is only done with two I-trays. Hereinafter, the term ‘raised’ is considered interchangeable with ‘leveled’ in regards to the MPT's pivoted position. Machines loaded onto the MPT in this manner can be vehicle-sized small engine machines with larger wheelbases or smaller machines with smaller wheelbases. In the case of the latter, the third aspect involving tray length adjustment allows such machines to be loaded onto the MPT. The flexible repair options can also affect the service speed and affect adjustments to adapt to less-than-ideal environments. For example, on a hill, the MPT can pivot at an angle that can stably hold a machine in that environment. In another example of adaptation, trays can also be retracted to a position closer to the MPT to take up less space in tight areas.

In the sixth aspect of the present disclosure, the MPT has a very small footprint, particularly when the MPT is fully closed. As noted, before, the MPT takes the form of a MPT. The outer surface is flush with the outer edge of the vehicle's rear side, while the inner MPT surface acts as an interior wall when the MPT is in an upright position. The TLTs are primarily metal plates that do not take up much room inside the vehicle's interior. The I-trays can also be concealed with the tray slots. The safety legs can pivot to be in line with the MPT so that it does not stick out from the service vehicle. The hydraulic cylinders are below the MPT and the vehicle's body; they also retract into openings on the MPT when the MPT pivots downward. In a sense, the MPT is fully integrated within parts of the vehicle rather than standing out as a standalone machine.

The MPT addresses problems previously found in existing lifts and on-spot repair machines. First, it increases the security and stability of both the MPT and the raised machine during repair work. This is thanks to two aspects: (1) the first aspect, where the hydraulic system is strong enough to raise and support a machine on the MPT; (2) the fourth aspect, where the safety legs support the MPT at a raised position and the WLH lock a machine's wheel in place. The two aspects work together to ensure that the machine is securely placed on the MPT and that the MPT stays put when in a raised position. More importantly, this increases safety for the user doing repair work due to the reduced risk of either the machine or MPT falling.

Second, the present disclosure increases space utilization of the device allows for increased interior space for the accommodating vehicle. In the sixth aspect of the present disclosure, the MPT has a minimal footprint. The MPT is practically the MPT of a service vehicle. When this door is closed, one side of the MPT lines up with the vehicle's exterior, while the other makes up an interior wall of the vehicle. The TLTs are mainly metal plates that do not take up much space inside the vehicle and are not fixed to a portion of interior vehicle space. Furthermore, the I-trays can be retracted fully into the MPT of the service vehicle. This feature is achieved using the third aspect of the present disclosure involving flexible and customizable setup options for the trays. Because space is available in the service vehicle, the first aspect of the MPT being both a ramp and load support mechanism applies here. A machine can move up the TLTs to be stored inside the service vehicle for repair or transport. This space improvement also improves the convenience of repair since additional tools can be stored inside the service vehicle for repairs equivalent to that of a typical brick-and-mortar setup.

Third, the device improves convenience for both the customer and the user. Because the MPT is an essential part of the service vehicle, it can be brought to a customer's location at any time. The customer does not have to bring a small engine machine to the shop, effectively saving time. The improved convenience also eases the entire operational process. First, the user presses a button on the remote to engage the HCs to bring the MPT outward and downward. The user then moves one end of the small engine machine onto the TLTs and MPT. In another sense, the convenience is improved for the user since they can also adjust the MPT to a level and angle that is comfortable for them using these aspects of the present disclosure. Within the same aspect, the user can go through the space between the TLTs to fix the machine.

Fourth, there is increased functionality for adjusting to different small engine machines with different track widths and engine placement. This is mainly thanks to the fifth aspect relating to flexible repair options, which actually comprises the former four aspects being applied differently to realize this increased functionality. In terms of increased functionality, the second and third aspects play a larger role. In the third aspect, I-trays can be placed at various lateral widths apart to accommodate the track widths of various machines. Using the second and third aspects of the present disclosure, the MPT can also simultaneously lift two vehicles using a combination of trays (e.g., L-tray and h-tray) set up in a particular manner. Another example of increased functionality is when a machine to be fully loaded onto the MPT with one track (front or back) on the MPT and the other track on the TLTs. For example, a machine with a rear engine goes onto the MPT with the rear track on a pair of I-trays. The first aspect enables the MPT to act as a ramp for this machine and raise the machine using the hydraulic cylinders; the machine is leveled when the MPT is raised, and the rear engine becomes accessible from the underside of the machine. Because the MPT can raise and support a machine on the MPT, the user can more effectively reach the underside of a machine for repairs. Applying both the first and third aspects, the user can adjust the longitudinal position of the I-trays so that machines with smaller wheelbases (e.g., snow blower or lawnmower) can be securely loaded onto the trays and MPT with the hydraulic load support raising the TLT.

Fifth, there is increased adaptability for repair work under less-than-ideal environments and conditions. The fifth aspect, relating to flexibility in repair options, plays a key role in realizing increased adaptability. As noted earlier, the fifth aspect is the combined application of the first four aspects to various degrees. The adaptability can be seen in a myriad of scenarios involving mobile repairs of small engine machines. For example, in bad weather conditions (e.g., rain, thunder, etc.), the first aspect allows the machine to travel on the MPT surface into the vehicle's interior to do accessible repairs. In another scenario, the service vehicle is situated on an uneven or sloped surface. One way to mitigate this is to control how much the MPT is raised so that the machine on it can be stable during repairs. Another adaptation to uneven surfaces involves the fourth aspect of the present disclosure, where the user adjusts the angles of the safety legs to achieve a flat, stable level as best as possible. One safety leg can be upright to touch the ground at one elevation. Another safety leg is pivoted at an angle from that upright position due to an elevated surface under that leg. In yet another scenario, there is not much space to work with because the area is crowded. The MPT can adapt to that by retracting the trays to be closer to the MPT or by placing the entire small engine machine onto the trays and ramp. By increasing the adaptability for repair work, the device also improves convenience and saves service repair time. This is because there is no need to move the MPT and service vehicle to a different location for repairs.

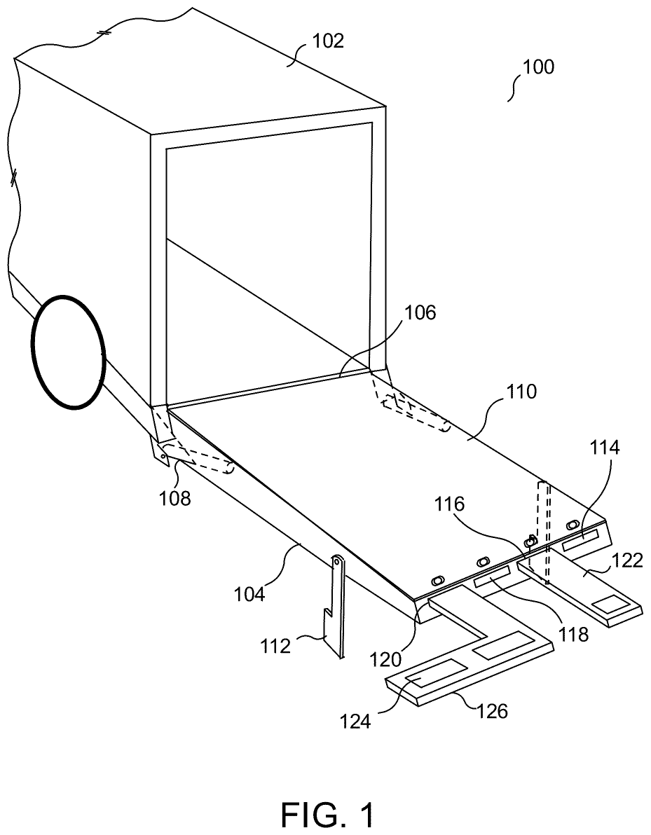

FIG. 1 illustrates a preferred embodiment of the MPT of the present disclosure in its open and raised position. The figure generally illustrates a perspective view of the MPT with a vehicle on the upper left side and the MPT expanding outward toward the lower right side. The invention (100) is located at the rear end of a vehicle (102). More specifically, the MPT (104) of the invention (100) makes up the rear end of the vehicle (102). One side of the MPT (104) faces away from the vehicle's (102) interior. This side of the MPT (104) faces the ground when the invention (100) is in the raised position. A MPT surfaces (110) covers the other side of the MPT (104), shown above the MPT (104) in the raised position. The MPT surface (110) faces the interior of the vehicle (102) when the MPT is upright. The MPT (104) and MPT surface (110) of the invention (100) pivot along pivot hinge (106) located at the bottom of the rear opening of the vehicle (102) in line with the flooring of its interior space. Two hydraulic cylinders (108) are located below the invention (100) and the vehicle's (102) body: one at the bottom left and another at the bottom right. The cylinders (108) pivot when the MPT (104) opens or closes; the cylinders (108) also extend or retract from openings on the MPT (104). Two safety legs (112) support the invention (100) in the raised position: one on each side of the MPT (104). Looking at the figure, the end of the MPT (104) pointing away from the vehicle (102), also considered the loading end, has four hollow tray slots (114, 116, 118, 120): a first tray slot (114) at the outer right edge; a second tray slot (116) at the middle right; a third tray slot (118) at the middle left; and a fourth tray slot (120) left at the outer left edge.

The invention (100) also comprises TLTs (122, 126) that support small engine machines when the invention (100) moves to the raised position: an I-tray (122) extends outward from the second tray slot (116) of the MPT (104); an L-tray (126) extends or retracts from the fourth tray slot (120) of the MPT (104). The TLTs (122, 126) have WLHs (124) to secure the wheel(s) of a vehicle-sized small engine machine as the invention (100) moves to the raised position.

The figure illustrates how increased security and stability are achieved. Relating to the aspect involving supplementary load support mechanisms, the safety legs (112) are support the invention (100) at 90-degree angles; the legs (122) are perpendicular to the MPT (104) and MPT surface (110) itself. As a result, the invention (100) is not likely to suddenly drop to the ground when supporting a small engine machine. The supplementary load support aspect also involves the WLHs (124) for the I-tray (122) and L-tray (126); this particular feature will be further shown in future figures.

Increased security and stability are also achieved thanks to the aspect involving the hydraulic system that pivots and stabilizes the invention (100) via hydraulic cylinders (‘HC’) (108). In doing so, the MPT (104) of the vehicle (102) can be a ramp and a load support mechanism. A hydraulic system is beneficial for the invention (100) because a large amount of pressure is generated from the HCs (108), making it better for heavy-duty applications such as lifting small machine engines. Hydraulic oil is simultaneously distributed to and from the HCs (108) in order to raise or lower the MPT (104). The HCs (108) are located at the left and right edges below the MPT (104), contributing to the load support on their respective side. As a result, the contribution to the load support is evenly distributed, and the invention (100) properly functions as a whole.

In an alternative embodiment, the system may be a purely electrical system with electrical cylinders. The benefits of an electric system include, but are not limited to: safer, cleaner, more efficient, cheaper, lower maintenance, longer service life, and easy installation. In another alternative embodiment, a pneumatic system with compressed gas is used. In one sense, a pneumatic system may help the device achieve the sixth aspect of a smaller footprint since pneumatic systems take up even less space compared to a hydraulic system. It is also cheaper. However, more maintenance is required for a pneumatic system.

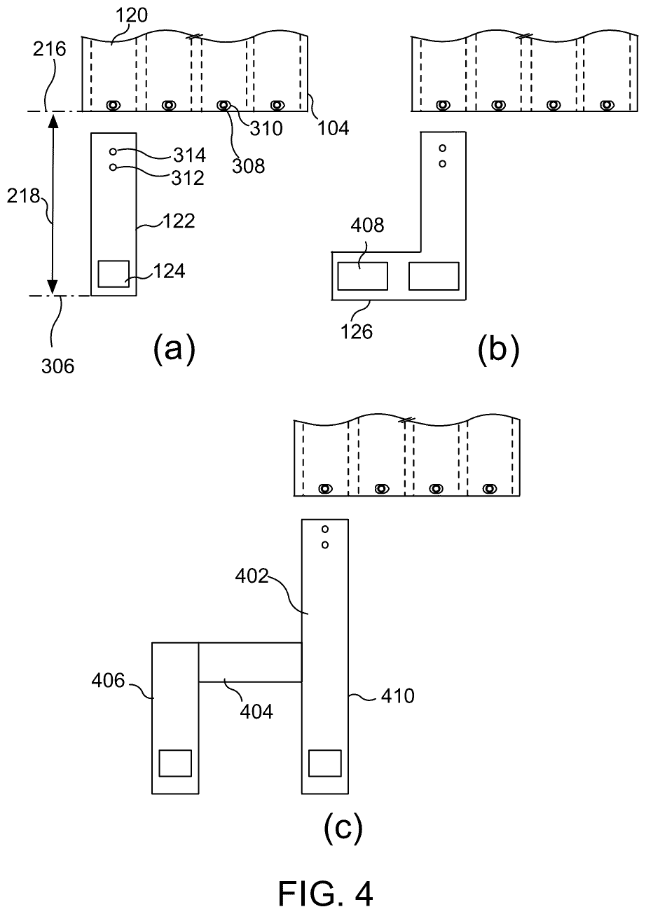

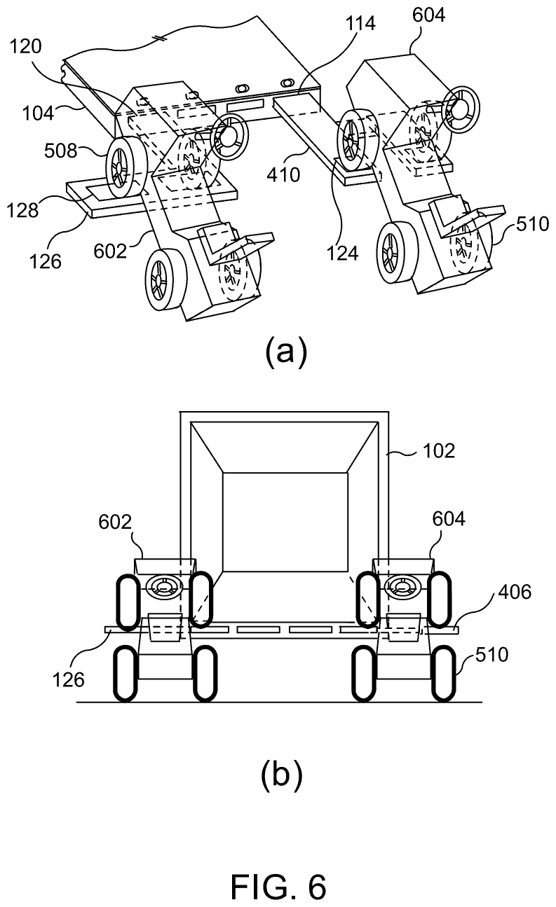

The figure also demonstrates the aspect involving various TLTs: the I-tray (122) and L-tray (126). The different trays (122,126) can be used depending on the machine in repair and the type of repair needed; this will be explained in future paragraphs and in FIGS. 4 and 6.

The figure also shows ample room inside the vehicle (102) with no mechanical components fixed onto the surfaces within the space itself. At most, a hinge (106) at the bottom of the vehicle's (102) MPT (104) opening is present to hold and pivot the MPT (104) itself. Thanks to the minimal footprint aspect, increased space utilization inside the vehicle (102) is achieved. This potentially allows for other tools and equipment to be stored. In a sense, the increased space utilization provides an opportunity to increase convenience in a way that provides repair services equal to that of a brick-and-mortar shop.

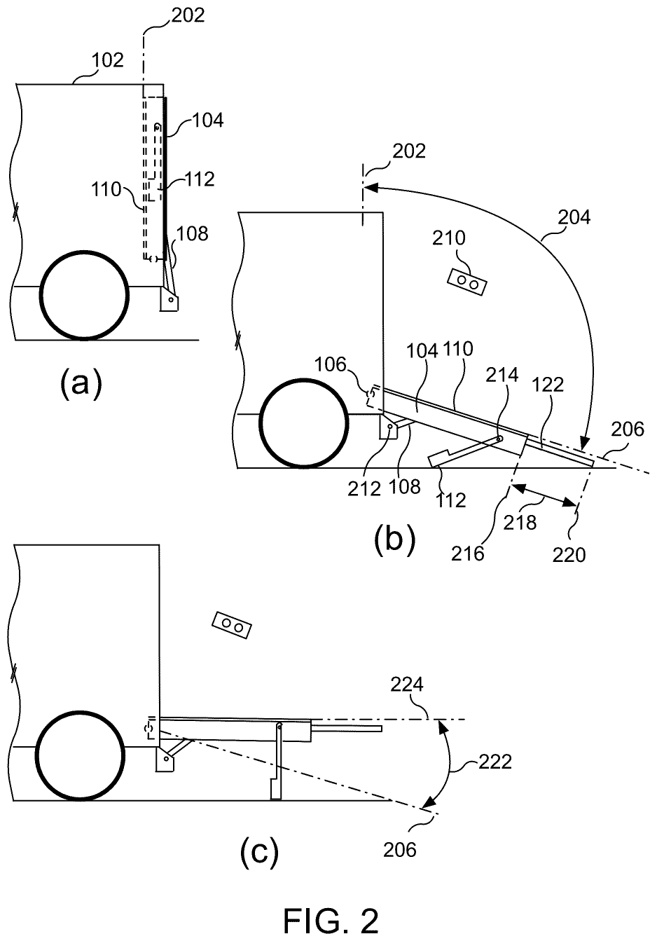

The minimal footprint aspect also relates to the cylinders (108) below the MPT (100) and the body of the vehicle (102), which are shown to be concealed within the MPT (104); this will be further shown in FIG. 2.

FIG. 2 illustrates side views of a MPT from its closed position to its sloped ramp position, then finally to its raised position. Looking at the figure, the vehicle (102) is shown on the left side and the MPT (104) on the right side. Sub-figure (a) illustrates a side view of the MPT (104) in a closed, retracted position. The MPT (104) starts in an initial MPT (104) closed position (202). A portion of the MPT (104) protrudes from the rear of the vehicle (102). A HC (108) is located below the MPT (104) and the vehicle's (102) body, which is fully exposed when the MPT (104) is in the initial closed MPT position (202). All other components are concealed inside the rear of the vehicle (102). A safety leg (112) is shown on one side of the MPT (104) with its long edge in line with the edges of the MPT (104) and MPT surface (110). The initial closed MPT position (202) is marked along the top edge of the MPT surface (110), shown at the top left edge of the MPT surface (110). An additional HC (108) and safety leg (112) are present on the other side of the vehicle (102) and MPT (104) and are not visible in the figure; however, it is obvious to those skilled in the art that they operate alongside their respective visible counterparts.

This sub-figure how increased space utilization is achieved using the minimal footprint aspect of the present disclosure. As the MPT (104) mainly comprises the MPT (104), the exterior facing side is mainly in line with the edge of the vehicle's (102) rear side, with nearly nothing protruding outward. The rest of the MPT (104) is inside the vehicle (102), but this is not a significant amount of space being used up. In truth, the sub-figure shows the MPT surface (110) integrated as an interior wall for the given space. The HCs (108) are outside the MPT (104) rather than inside the vehicle's (102) interior space. The HCs (108) are also angled in a way that is still in line with the rest of the vehicle's (102) rear side.

Sub-figure (b) illustrates the MPT (104) in a sloped open MPT position (206). The user presses a button on a remote (210) to activate the MPT. The MPT (104) pivots along a hinge (106) at the bottom of the vehicle's (102) rear opening in line with the interior space's flooring. The MPT (104) moves downward with a pivoting door movement (204) from the initial closed MPT position (202) to the sloped open MPT position (206). The sloped open MPT position (206) is marked along the top edge of the MPT surface (110). The MPT (104) can also move upward with a pivoting door movement (204) from the sloped open MPT position (206) to the initial closed MPT position (202). A HC (108) guides the pivoting door movement (204). More specifically, the HC (108) rotates along with the pivot joint (212) below the MPT (104) and the vehicle's (102) body to influence the MPT's (104) movement. As the MPT (104) moves to the sloped open MPT position (206), the cylinder (108) mostly retracts into the MPT (104) via an opening on the edge of the MPT (104).

At the same time, the safety leg (112) rotates along with the swivel joint (214). During the movement of the MPT (104), the safety leg (112) has already contacted the ground prior to reaching the sloped open MPT position (206); this will be shown in the next sub-figure. When moving to the sloped open MPT position (206), the safety leg (112) slides to an angled position due to the force acting on the component during the MPT's (104) movement downward. A tray-particularly an I-tray (122) extends from their initial tray retracted position (216) inside the MPT (104) to make physical contact with the ground. The I-tray (122) extends outward with a telescoping tray movement (218) from its initial retracted tray position (216) to a final extended tray position (220). The I-tray (122) can also retract inward with a telescoping tray movement (218) from the final extended tray position (220) to the initial retracted tray position (216).

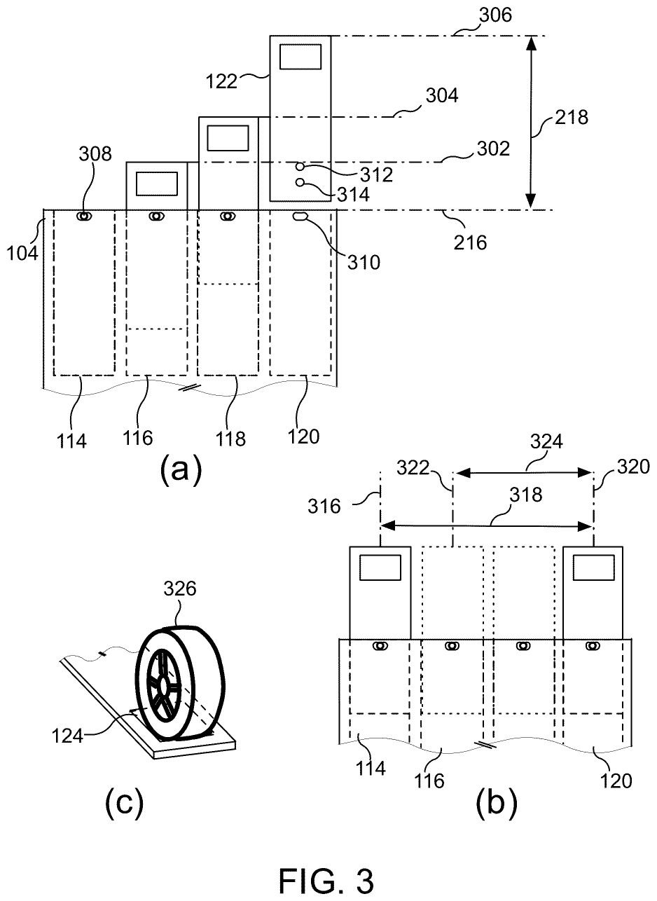

The HC (108), safety leg (112), pivot and swivel joints (212, 214) respectively, and I-tray (122) are described as singular items since only one side of the MPT (104) is visible. It is obvious to those skilled in the art that these components are also present on the other side of the MPT (104) and are not visible. It should also be noted that the additional I-tray (122) can be located a certain lateral distance away from the visible I-tray (122) rather than solely on the other side of the MPT (104); this will be further shown in FIG. 3.

The sub-figure shows the tray customization aspect relating to the adjustable length of the I-trays (122), as well as the minimal footprint aspect. This aspect achieves several improvements, such as increased space utilization and improved functionality. This will be further demonstrated and explained in future paragraphs and in FIG. 3. It should also be noted that although the I-tray (122) is shown in this figure, the L-tray and h-tray may also be used instead. It is obvious to those skilled in the art that the L-tray and h-tray cannot fully retract into the MPT (104) and that they would need to be first inserted from the outside prior to loading a small engine machine on the MPT (104).

Although the I-tray (122) shown in the sub-figure can extend from the MPT (104), it can also be removed entirely and inserted from a removed position; this will be further shown in FIG. 3.

Generally, the I-trays (122) need to be brought out manually as an extra step in the whole procedure. In an alternative embodiment, the I-trays (122) extend automatically, preferably at the same time as the pivoting movement of the MPT (104). This will increase convenience because the user can save time and effort in bringing out the I-trays (122). However, such a setup would need a modified hydraulic system and MPT (104) design. Furthermore, only the I-trays (122) can be used in this embodiment, and they would not be removable from the MPT (104). The remote (210) achieves improved convenience since the user only needs to press a button to activate the MPT (104). The remote (210) in this figure is a general representation. In this figure, the remote (210) is illustrated with two buttons; each button triggers the MPT (104) to move in a particular direction when held down. It is assumed that the movement stops movement in one direction when the MPT (104) physically touches the ground or the vehicle (102). An additional button may be used to lock the MPT (104) in place, so the user would not activate the MPT's (104) movement even when pressing the activation buttons. It should also be noted that the remote (210) in the present disclosure is wireless. In another embodiment, the remote (202) may be wired.

Sub-figure (c) illustrates the MPT (104) raised to a flat open MPT position (224). The MPT (104) starts in a sloped open MPT (104) position (206), as shown in sub-figure (b). The user presses a button on the remote (210) to raise and lower the MPT (104). The device moves upward with a pivoting door movement (222) to the flat open MPT position (224). The MPT (104) can also move upward with a pivoting door movement (222) from the flat open MPT position (224) to the sloped open MPT position (206). The pivoting door movement (222) is caused by each HC (108) rotating along pivot joint (212) below the MPT and the vehicle's (102) body. As the MPT (104) moves to the flat open MPT position (224), each HC (108) becomes slightly exposed. At the same time, each safety leg (112) rotates along with the swivel joint (214) back to an upright position that contacts the ground. This may be done with gravity, or it can be manually adjusted.

The HCs (108) play some role in the minimal footprint aspect. Here, the HCs (108) recede into openings on the side edges of the MPT (104), one on each side. The cylinders (108) line up with the MPT (104) itself, particularly when the MPT (104) is at the sloped open MPT position (206). As a result, the HCs (108) do not stand out and take up extra space.

The movement of the MPT (104) itself appears to have an increased range thanks to the aspect involving the hydraulic system pivoting the MPT (104) via HCs (108). It can be assumed that the HCs (108) have rods inside the MPT (104) that extend or retract as the MPT (104) pivots. Such rods do not elongate or compress the MPT (104) during the MPT's (104) movement. Rather, they would mainly affect the exposure of the HCs (108) during the MPT's (104) movement. The MPT (104) would appear to have a more dynamic range as it pivots. In a way, improved convenience may be achieved by providing the user with a larger workspace area.

When the MPT (104) moves from the initial closed MPT position (202) to the sloped open MPT position (206), the safety legs (112) naturally pivot to an upright position with the use of gravity. The safety legs (112) touch the ground prior to reaching the sloped open MPT position (206), as shown in FIG. 1. To reach the sloped open position (206), the safety legs (112) slide back into an angled position as a result of force being exerted on the safety legs (112) during the MPT's (104) downward movement. This can be easily done assuming that the friction of the ground is not high. As a result, the safety legs (112) can still support the MPT (104) in the sloped open position (206).

The safety legs (112) can be applied in a way that achieves improved adaptability. In one scenario, the service vehicle is situated on an uneven surface. One way to mitigate this is to adjust the angles of the safety legs (112) in order to stabilize the lifer at a flat, even level as best as possible. One safety leg (112) may be upright to touch the ground at one elevation level, while another is safety leg (112) is pivoted at an angle to adapt to an elevated surface under that leg (112).

While gravity generally causes the safety legs (112) to pivot, manual adjustment of the legs (112) is sometimes needed whenever the MPT (104) opens or closes. In an alternative embodiment, the safety legs (112) are controlled remotely to pivot automatically. That way, improved convenience can be achieved since the user does not have to manually adjust the safety legs (112). Additional buttons on the remote may be assigned to activate this feature, although extra components may be required (e.g., electrical wiring), which may affect the footprint of the device.

FIG. 3 illustrates a perspective view of a machine wheel secured on a wheel lock and top views of various installation options of multiple I-shaped trays (122), including tray length and track width adjustment. Sub-figure (a) illustrates multiple I-trays (122) extended from the tray slots at different lengths or longitudinal positions. From the top view perspective, the MPT (104) and the I-trays (122) are shown with their loading ends pointing upward. The I-trays (122) are stored inside the tray slots (114, 116, 118, 120) with openings at the outward loading end of the MPT (104): one I-tray (122) is stored entirely in the first tray slot (114), shown on the outer left side of the MPT (104). This I-tray (122) is positioned in the initial retracted tray position (216) shown in FIG. 2. From this perspective, it is marked at the top of the I-tray (122); another I-tray (122) extends slightly outward to an extended position (302) from the second tray slot (116), shown on the inner left side of the MPT (104); another I-tray (122) extends farther outward to an extended position (304) from the third tray slot (118), shown on the inner right side of the MPT (104); a fully exposed I-tray (122) is completely outside the MPT (104) in a removed position (306). This I-tray (122) is aligned with the fourth tray slot (120), shown on the outer right side of the MPT (104). All I-trays (122) in this sub-figure extend from or retract into the MPT (104) with a telescoping tray movement (218).

Each I-tray (122) has two vertically aligned tray pin slots: a first tray pin slot (312) and a second tray pin slot (314). The tray pin slots (312, 314) line up with a tray pin holder slot (310) on the top side of the MPT (104). When aligned, a tray locking pin (308) is manually inserted into the pin holder slot (310) and tray pin slots (312, 314) to lock the I-tray (122) in place. In this sub-figure, no tray locking pin (308) is present in the pin holder slot (310) at the fourth tray slot (120) since the entire I-tray (122) is aligned with that slot (120) in the removed position (306).

Although the sub-figure shows the telescoping tray movement (218) of the I-trays (122), the L-trays (126) and h-trays (410) are also longitudinally adjusted in the same manner. It is obvious to those skilled in the art that L-tray (126) and h-tray (410) cannot fully retract into the MPT (104) as an I-tray (122) would.

The I-tray (122) in the initial retracted tray position (216) is an example of how the minimal footprint aspect is achieved since the tray (122) can fully integrate into the MPT (104) and not take up extra space in a service vehicle's interior. Even when removed, any present tray (122) does not take up much space inside the vehicle.

While the tray locking mechanism is one part of the tray customization aspect, it can also play a role in the flexibility in repair options, leading to improved adaptability. For example, a mobile repair is required, but there is limited space in the area given. The I-trays (122) can be locked in place by lining up their first tray pin slots (312) with the respective pin holder slots (310) (depending on tray slots (114, 116, 118, 120) chosen) to bring the I-trays (122) closer to the MPT (104); therefore, less space is taken up. On the other hand, if a user needs more space to work on repairs, the I-trays (122) can be locked in place by lining up their second tray pin slots (314) with the respective pin holder slots (310) (depending on tray slots (114, 116, 118, 120) chosen) to bring the I-trays (122) farther away from the MPT (104). This scenario would increase both conveniences for the user and adaptability of the MPT.

Extended positions (302) and (304) are two exemplary positions to show where the I-trays (122) can be moved based on the telescoping tray movement (218). Likewise, the tray pin slots (312, 314) are just examples of the positions for locking the trays (122) in place. In actuality, the I-trays (122) can be moved and locked into any position between the initial retracted position (218) and the removed position (306). For locking, there could be multiple tray pin slots (312, 314) in an alternative embodiment for more locking positions. In yet another alternative embodiment, a long continuous slot may allow for even more precision in where the I-tray (122) or any other tray can be locked. By using this particular embodiment, further adaptability may be achieved since the I-tray (122) positioning can be better adjusted in a given working space.

The telescoping tray movement (218) shown in this sub-figure also allows for a small engine machine's wheelbase to be taken into consideration. For a machine with a shorter wheelbase, the I-trays (122) can move into a more retracted position so that the machine can be secure on both the I-trays (122) and the MPT (104). This could improve the functionality of the MPT (104) device to accommodate such machines. This would require the MPT (104) to pivot further downward. In an alternative embodiment, this could be better achieved by modifying the MPT size (104) and/or the bottom edge of the service vehicle.

Sub-figure (b) illustrates a top view of the track width adjustment with the trays. Specifically, the I-trays (122) can be inserted into any one of the tray slots (114, 116, 118, 120) to accommodate the track widths of various vehicle-sized small engine machines. A first tray (316) is situated in the first tray slot (114), and a fourth tray (320) is situated in the fourth tray slot (120). The two trays (316, 320) are separated by the maximum tray distance (318) to accommodate a small engine machine with a wide track width. In an alternative scenario, a second tray (322) is situated in the second tray slot (116); it is separated from the fourth tray (320) by an alternative tray distance (324).

By adjusting the lateral tray distance (318, 324) between the trays (316, 320, 322), improved functionality can be achieved due to the accommodation of different machines with different track widths. The working space may also be affected by this type of adjustment. In a sense, it can create convenience for the user to go in between the spaces between the first tray (316) or second tray (322) and the fourth tray (320).

The adjustment of tray distances (318, 324) can be used to set up a tray combination in a way that allows for simultaneous repairs for two small engine machines, increasing the functionality of the MPT (104). This will be further explained in future paragraphs and in FIG. 6.

Sub-figure (c) illustrates a perspective view of a small engine machine wheel on an I-tray (122). One wheel (326) from a small engine machine is fitted onto the WLHs (124) of an I-tray (122). More specifically, the bottom portion of the wheel (326) goes through the WLHs (124), which secures the machine in place when the MPT (104) moves.

When the MPT (104) moves, the wheel on the I-tray (122) also moves to some degree. Because the bottom part of the wheel (326) goes past the wheel lock (124), any movement from the wheel (326) during the MPT's (104) movement is contained within the WLHs (124) and never goes past it. In other words, if a wheel (326) moves during the MPT's (104) movement, it moves back into the WLH (124) shortly after. It is obvious to those skilled in the art that straps should be used to optimally secure the wheel (326) of the machine on the MPT (104). In an alternative embodiment, the WLH (124) can have a sort of locking mechanism to further secure the wheel (326); however, this may affect the I-tray's (122) ability to retract into the MPT (104).

FIG. 4 illustrates top views of various types of other trays, including I-shaped, L-shaped, and h-shaped trays. The trays (122,126,410) are shown with an inserting end facing upward and the loading end facing downward. The MPT (104) is shown with the outward loading end facing downward and the tray slot openings facing downward. Sub-figure (a) illustrates the top view of an I-tray (122) entering the fourth tray slot (120). All descriptions of the I-tray and telescoping tray movement in previous figures also apply here. The I-tray (122) starts at a removed position (306) and lines up with the fourth tray slot (120). It can then enter the fourth tray slot (120) to a retracted tray position (216) with a telescoping tray movement. The I-tray (122) can also extend outward to a removed position (306) from a retracted tray position (216) with a telescoping tray movement (218). The I-tray (122) is inserted into the fourth tray slot (120), and one of the two tray pin slots (312, 314) lines up with the pin holder slot (310) on the MPT (104). Once the I-tray (122) is in the desired position, a locking ramp pin (308) is inserted into the pin holder slot (310) and selected tray pin slot (312, 314) to lock the I-tray (122) in place.

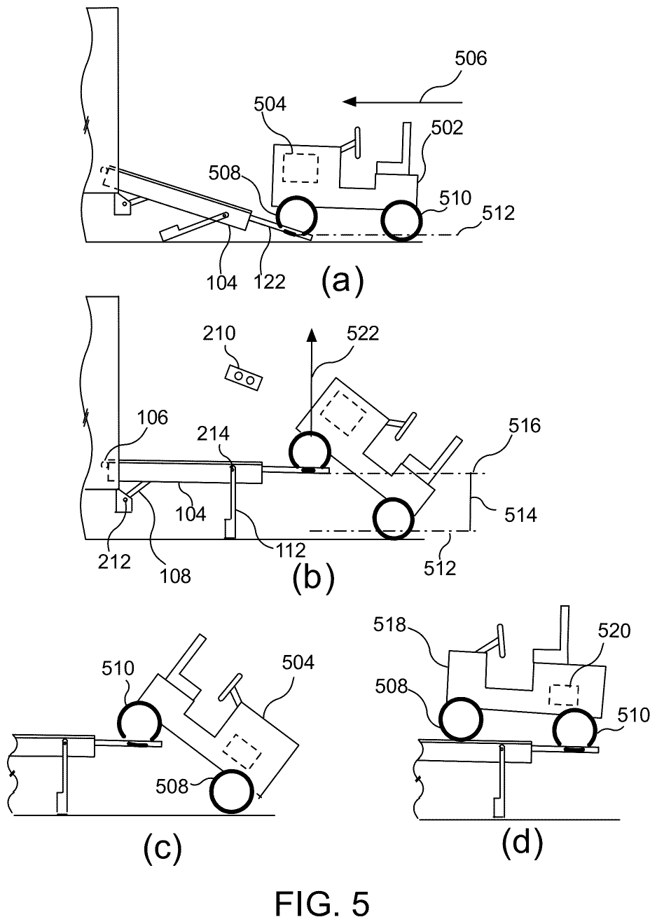

The I-tray (122) is the standard tray used to lift a small engine machine, so two are needed to lift a machine's track. However, the I-tray is suitable for retraction into the MPT (104) and can be used for track width adjustments. The I-tray (122) is the only one that allows a small engine machine to load in a way where one track is on the MPT (104) and the other is on the I-tray (122) and wheel lock (124). Overall, this improves the functionality of the MPT (104). This will be shown in FIG. 5.

Sub-figure (b) illustrates the top view of an L-tray (126) entering the fourth tray slot (120) of the MPT (104). All descriptions of the tray slot, tray pin slots, pin holder slot, MPT (104), and locking ramp pin also apply here. The L-tray (126) comprises a single metal plate with two perpendicular segments in the shape of the letter ‘L’. One vertical segment of the L-tray (126) is lined up with the fourth tray slot (120). The other horizontal segment of the L-tray (126) has two elongated wheel locking holes (408) for loading the track of a small engine machine.

The elongated wheel locking holes (408) of the L-tray (126) achieve improved functionality because they can accommodate small engine machines with different track widths in the same way as two I-trays (122) spaced laterally apart. Furthermore, a small engine machine with a smaller track width has more flexibility in how it is laterally placed on the L-tray (126).

It is obvious to those skilled in the art that the L-tray (126) should be placed in the manner shown in the sub-figure so that it does not block the other tray slots. Furthermore, this particular placement is needed so that another tray can be placed at the end in order to simultaneously repair multiple machines; this is the key to achieve flexible repair options and further improve the functionality of the MPT (104). This will be further demonstrated in future paragraphs and in FIG. 6.

Sub-figure (c) illustrates the top view of an h-tray (410) entering the fourth tray slot (120) of the MPT. All descriptions of the tray slot, tray pin slots, pin holder slot, MPT (104), and locking ramp pin also apply here. The h-tray (410) comprises three sections: a longer insertion segment (402) with two tray pin slots (312, 314). The insertion segment (402) is practically an elongated I-tray that lines up and enters the fourth tray slot (120); a shorter outward segment (406); a perpendicular bridging segment (404) in the middle.

The insertion segment (402) always lines up with one of the tray slots: in this case, the fourth tray slot (120). However, the h-tray (410) itself can be flipped so that the outward segment (406) faces the other way. Looking at sub-figure (c), the outward segment (406) and the bridging segment (404) will be on the right side of the insertion segment (402) rather than the left. It is obvious to those skilled in the art that flipping the h-tray (410) in this manner would mean that it should be inserted into another tray slot, namely a tray slot at the opposite end of the MPT (104) like the first or second tray slots. That way, other trays (122, 126, 410)—like an L-tray (126)—can be inserted into the fourth tray slot (120). This setup will be further shown in FIG. 6.

The h-tray (410) is primarily for better accessing the underside of a small engine machine, thanks to the space between the insertion segment (402) and outward segment (406). The h-tray (410) has a fixed track width and cannot be used to accommodate small engine machines with different track widths. This track width can be adjusted in other embodiments by elongating the bridging segment (404). Not only will the track width be wider, but the user may be able to access the underside more easily.

The trays (122, 126, 410) are all demonstrations of the tray variation aspect of the present disclosure. By using different types of trays (122, 126, 410), the user can place a machine onto the MPT (104) based on the needs of the machine (e.g., type of repair) and the user is fixing it. In a sense, the tray variation improves both the functionality of the MPT (104) and convenience for the user.

All the trays (122, 126, 410) in this figure are solid objects, although the h-tray (410) consists of three solid segments (402, 404, 406) fixed together to work as one tray. In an alternative embodiment, the trays (122, 126, 410) have telescoping or folding segments to further enhance the minimal footprint aspect. While this may be a minor benefit for the I-tray (122), it could be a major improvement for the h-tray (410) and L-tray (126).

FIG. 5 illustrates side views relating to how MPT (104) raises a front-engine and back-engine machine for onsite repairs. Sub-figure (a) illustrates a side view of the MPT (104) extended at ground level in order to load a vehicle-sized small engine machine. The MPT (104) is open in an extended position, as shown in FIG. 2(b): the MPT (104) is sloped downward, and the I-trays (122) have extended to the ground. A vehicle-sized small engine machine (502) has a front-facing engine (604) at the front needing repairs. Hereinafter, the term ‘vehicle-sized small engine machine’ is interchangeable with ‘front-engine machine’ and ‘first machine’. Because the front-engine machine (502) is particularly large, the track width of the MPT (104) is adjusted by moving the I-trays (122) to different tray slots so that they are wider apart. The first machine (502) then moves in a direction (506) toward the MPT (104) MPT (104). The front-engine machine (502) stops moving when its front track (508) is loaded and secured onto the I-trays (122). The front track (508) is situated in an initial front wheel position (512). The rear wheels (510) of the machine (502) remain on the ground.

Sub-figure (b) illustrates the side view of the MPT (104) in a raised position with an elevated first machine (502). All descriptions of the MPT (104) and its components from FIG. 2 also apply here. The MPT (104) elevates to the raised position with the remote (210), which causes the following to occur: the MPT (104) pivots along a hinge (106); the HCs (108) pivot along pivot joints (212); the safety legs (112) pivot along swivel joints (214). The front wheels (508) of the first machine (502) are raised (522) to an elevated wheel position (516) with a vertical front wheel movement (514). The wheels (508) can also move with the vertical front wheel movement from the elevated wheel position (516) to the initial front wheel position (512). As a result, the user is able to access the underside and the top side of the first machine (502).

The elevated wheel position (516) can be at any height above the initial front wheel position (512), depending on how much the MPT (104) is raised. This elevated wheel position (516) can be adjusted based on the user's preference, the type of machine, and the type of repair needed, which improves the overall convenience of repairs for the user.

Sub-figure (c) illustrates the side view of the MPT (104) at a raised position with an alternative version of the first machine (502). Here, the rear wheels (510) of the first machine (502) are loaded onto the trays (122), while the front wheels (508) remain on the ground. The front-facing engine (504) faces away from the MPT (104).

Sub-figure (d) illustrates the side view of the MPT (104) at a raised position with an alternative rear-engine machine (520). The machine (518) has a rear-facing engine (520) at the back next to the rear wheels (510). Hereinafter, the term ‘rear-engine machine’ is interchangeable with ‘second machine’. The front wheels (508) of the second machine (518) are placed on top of the MPT (104) itself. The rear wheels (510) are secured onto the I-trays (122). The second machine (518) is also elevated to a flat, leveled position as the MPT (104) moves to a raised position.

Sub-figures (c) and (d) demonstrate the aspect relating to the flexibility of repair work. They generally show how the first and second machines (502, 518) can be arranged in different positions to achieve both increased functionality and increased adaptability. The positions of the machines (502, 518) shown in this figure are generally dependent on the type of repair needed. In sub-figure (d), the functionality can be improved by using the customizable setup of trays (122) to bring a machine (502, 518) with a small wheelbase on both the MPT (104) and the trays (122). When it comes to improving adaptability, sub-figure (d) is a good example of saving space for repair work, particularly when there is little space to work around, such as a crowded parking lot.

All sub-figures show an applicable example of how the MPT (104) with a first and second machine (502, 518) achieves increased security and stability. The MPT (104) moves as the HCs (108) pivot along pivot joints (212) to lift and support the machines (502, 518). The MPT (104) is shown as both an on-boarding ramp with the I-trays (122) and as a load support mechanism upon pivoting the MPT (104) to the final raised position. The figures also show the safety legs (112) supporting the MPT (104) at the raised position to reduce the risk of both the machines (502, 518) and the MPT (104) suddenly falling down. The wheels (508, 510) are shown to go through the I-trays (122) to demonstrate the increased security on the MPT (104).

FIG. 6 illustrates a perspective and rear views of a single MPT (104) simultaneously repairing two machines using L-shaped and h-shaped trays. Sub-figure (a) illustrates the perspective view of the MPT (104) raising two vehicles. The MPT (104) is raised to a flat, leveled position. On the outer left end of the MPT (104), an L-tray (126) is situated in the fourth tray slot (120). The L-tray (126) lifts a first tractor (602) at an upward angle. The first tractor's (602) front wheels (508) are loaded and secured on the elongated WLHs (408) of the L-tray (126). On the outer right end of the MPT (104), the fourth tray slot (114) holds an h-tray (410) in place via the h-tray's (410) insertion segment. The h-tray (410) lifts a second tractor (604) at an upward angle; the front wheels (508) are loaded and secured on the wheel locking holes (124) of the h-tray (410).

Sub-figure (b) illustrates the rear view of the MPT (104) raising two tractors (602, 604). All descriptions of the trays, tray slots, vehicles, and MPT (104) in sub-figure (a) also apply here. The MPT (104) and the two tractors (602 604) are in front of an associated service vehicle (102). The sub-figure also shows the right front wheel (508) of the second tractor (604) on the outward segment (406) of the h-tray (410). The tractors' (602, 604) rear wheels (510) are situated on the ground.

The first and second tractors (602, 604) in the figure are shown with their front wheels (508) on the L-tray (126) and h-tray (410), respectively. Variations in the tractors' (602, 604) placements can be applied in other embodiments, including the rear wheels (510) on the WLHs (124, 408) of the trays (126, 410), or one tractor (602, 604) with the front wheels (508) loaded on one tray (126, 410) and another tractor (602, 604) with rear wheels (510) loaded on the other tray (126, 410).

The figure shows how the MPT (104) achieves increased functionality through the aspect relating to the flexibility of repair options. Specifically, the tray variation and setup customization aspects serve as the basis for the flexibility in repair options. The figure also shows the practical application of the WLHs (124, 408) securing the front wheels (508) of both tractors (602, 604).

Although not shown in the figure, the load support mechanisms involving the hydraulic system and safety legs also play a role in supporting the weight of two tractors (602, 604). As noted earlier, the hydraulic system is strong enough to lift heavy objects. When hydraulic fluid is distributed within the cylinders, it is done so simultaneously to support the weight of the tractors (602, 604). The HCs (108) are also placed along the two edges of the MPT (104). The safety legs are located on each side of the MPT (104), as shown in FIG. 1. As a result, the load support is evenly distributed when the MPT (104) supports the tractors (602, 604). It is possible to move either the h-tray (410) or the L-tray (126) to one of the center tray slots in other embodiments as a way to adapt to tight spaces or avoid obstacles on one side of the MPT. Doing so may exemplify the increased adaptability of the MPT (104).

In an alternative embodiment, the MPT (104) can be split into two separate ramps that can individually lift a single machine or tractor (602, 604). In a sense, this improves the MPT's (104) functionality mainly due to the ability to adjust the MPT (104) in order to accommodate two drastically different machines with different properties (e.g., weight, wheel track, etc.). However, the customization of tray setup becomes fairly limited in that only two slots are available for each MPT (104). For example, each smaller MPT (104) can hold two I-trays right next to each other, limiting the flexibility since the track widths of most small engine machines may not fit on the trays and wheel locking holes (124, 408).

FIG. 7 includes the method for performing repairs on small engine machines at a client's location comprising the following steps: pressing a button on the remote and engaging the HCs. The HCs then lowering the MPT; the user then removes the telescoping loading trays from the MPT and attaching the TLTs to the MPT; once the TLTs are in the MPT by aligning pin slots and tray pin slots and installing tray locking pins; the user lowers the safety legs; the front machine wheels are then loaded into WLHs; another button on the remote is pressed engaging the hydraulic cylinders that raise the MPT so the user can work underneath the machine.

1. A multipurpose tailgate (MPT) for a service vehicle, the MPT comprising:
a) a vehicle-mounted tailgate door pivotally connected to a hinge at a rear opening of the service vehicle;
b) a hydraulic system comprising a pair of hydraulic cylinders, each hydraulic cylinder pivotally coupled between the MPT and the service vehicle, the hydraulic system configured to move the MPT between a closed position, a sloped ramp position, and a raised position;
c) a plurality of telescoping loading trays (TLTs), each TLT being removably insertable into one of a plurality of tray slots disposed along a loading edge of the MPT opposite the hinge, each TLT being selectively extendable and retractable to adjust its length;
d) a locking mechanism for securing each TLT within a selected tray slot, the locking mechanism comprising a plurality of tray locking pin slots at an insertion end of each TLT, the tray locking pin slots being configured to receive a locking pin for securing the TLT in one of multiple longitudinal positions;
e) a safety support system comprising a pair of safety legs pivotally coupled to opposite sides of the MPT, the safety legs being movable between a stowed position and a deployed position, wherein in the deployed position, the safety legs engage a ground surface to stabilize the MPT when in the raised position;
f) a plurality of wheel locking holes (WLHs) disposed on at least some of the TLTs, the WLHs configured to receive and secure a wheel of a small engine machine during operation of the MPT; and
g) wherein the MPT is configured to function as both a loading ramp for moving a small engine machine onto the service vehicle and a load support platform for repairing the small engine machine when in the raised position.

2. The MPT of claim 1, wherein the plurality of TLTs further comprising:
a) at least one I-shaped tray (I-tray) having a planar structure with at least one WLH for securing a wheel of the small engine machine;
b) at least one L-shaped tray (L-tray) having a vertical insertion segment for engaging a tray slot and a horizontal segment extending perpendicularly therefrom, the horizontal segment comprising a pair of elongated WLHs for accommodating small engine machines with varying track widths; and
c) at least one h-shaped tray (h-tray) comprising an insertion segment for engaging a tray slot, an outward segment spaced apart from the insertion segment, and a bridging segment connecting the insertion segment and the outward segment, the h-tray being configured to support a small engine machine while providing access to an underside of the machine for repair operations.

3. The MPT of claim 1, wherein the hydraulic system is configured to simultaneously extend or retract the pair of hydraulic cylinders to raise or lower the MPT in a synchronized manner.

4. The MPT of claim 1, wherein each safety leg is pivotally coupled to the MPT via a swivel joint, allowing the safety leg to be manually or automatically adjusted to maintain stability on uneven ground surfaces.

5. The MPT of claim 1, further comprising a remote control system configured to activate and control the movement of the MPT between the closed position, the sloped ramp position, and the raised position.

6. The MPT of claim 1, wherein the plurality of tray slots are spaced apart along the loading edge of the MPT to allow for selective lateral positioning of the TLTs to accommodate small engine machines of different track widths.

7. The MPT of claim 2, wherein the h-tray is configured to be flipped for insertion into different tray slots to accommodate different small engine machine orientations.

8. The MPT of claim 1, wherein the hydraulic system is a hydraulic oil-based system, an electrically actuated system, or a pneumatic system.

9. The MPT of claim 1, wherein the WLHs are configured to secure a machine's wheels during elevation to prevent movement of the machine while repairs are performed.

10. The MPT of claim 1, wherein the MPT is configured to be retrofitted onto existing service vehicles by replacing an existing tailgate with the MPT.

11. The MPT of claim 1, wherein the MPT is configured to support multiple small engine machines simultaneously using different combinations of TLTs.

12. The MPT of claim 1, wherein the hydraulic cylinders are concealed within the MPT when in the closed position to minimize the footprint of the MPT.
